(19) United States
(12) Patent Application Publication
(10) Pub. No.: US 2018/0030927 A1
(43) Pub. Date: Feb. 1, 2018

(54) PROPELLANT GRAIN FOR A SOLID ROCKET MOTOR

(71) Applicant: Chairman, Defence Research & Development Organisation (DRDO), New Delhi (IN)

(72) Inventors: Anish Bala Krishnan, Hyderabad, Telangana (IN); Marudhanayagam Manickavasagam, Hyderabad, Telangana (IN); Vekataswamy Gnanasekaran, Hyderabad, Telangana (IN)

(21) Appl. No.: 15/550,690

(22) PCT Filed: Jul. 3, 2015
(86) PCT No.: PCT/IB2015/055027

§ 371 Date: Aug. 11, 2017

(30) Foreign Application Priority Data
Feb. 12, 2015 (IN) 407/DEL/2015

(51) Int. Cl. F02K 9/10; F02K 9/34

(52) U.S. Cl. CPC F02K 9/10; F02K 9/346; F05D 2220/80

(57) ABSTRACT

The present disclosure relates to propellant grain configuration in solid rocket motors. In one embodiment, the propellant grain is a case-bonded, forward-swept, deep finocyl grain offering significant flexibility in tailoring burn surface area regression profiles to meet different performance requirements even while allowing for high propellant volumetric loading densities. The grain comprises of two or more longitudinal fin cavities with forward swept leading edges, circular-patterned about an axial cavity.

### FIELD OF THE INVENTION

The present disclosure primarily relates to solid rocket motors, more particularly, to propellant grain configuration for use in solid rocket motors.

### BACKGROUND

To meet increasingly demanding performance requirements from solid rocket motors, new propellant grain configurations are conceived. Many factors contribute towards building a high performance solid rocket motor. Two of the geometric factors are high ‘propellant volumetric loading density’ and flexibility to tailor ‘grain regression pattern’ to deliver different mission-specific thrust profiles. Conventionally grain designers have used a variety of grain configurations viz. star, finocyl and conocyl, to name a few, with varying degrees of relative merits, to meet different requirements. Among them, finocyl is a versatile grain configuration that allows for high loading density as well as thrust tailoring flexibility. A finocyl grain configuration comprises of an axial cavity surrounded by longitudinal fin cavities in cyclic symmetry. By altering the size, shape, location and number of fin, finocyl grains can be configured for a variety of thrust profiles.

FIGS. 1a & 1b show the aft-end view and longitudinal sectional view respectively of a monolithic solid rocket motor with conventional shallow finocyl grain as in prior art. When the largest imaginary circle circumscribing the fin tips is smaller than the largest motor aperture, it is called shallow finocyl grain. The rocket motor 100 comprises an internally insulated motor casing 101 with apertures 102 and 103 at the front end (alternatively referred to as fore-end) and rear end (alternatively referred to as aft-end) respectively. Generally fore-end aperture is smaller than aft-end aperture. In a typical rocket motor, an igniter (not shown) closes the fore-end aperture 102; a nozzle (not shown) closes the aft-end aperture 103. The rocket motor 100 further comprises propellant grain 104 with an axial cavity 105 and number of shallow fin 106a having reverse-swept leading edges 107a. When the leading edge 107a makes an obtuse angle 108a with the forward motor axis 101a, the fin are called reverse-swept. The propellant grain 104 further comprises a counter-bore 109 at the aft-end to accommodate a submerged nozzle (not shown) of the rocket motor 100.

FIG. 2 shows the longitudinal section view of a rocket motor with conventional deep finocyl grain as in prior art. Since the largest imaginary circle circumscribing the fin tips is bigger than the largest motor aperture 102, it is called deep finocyl grain. The deep fin 106b is once again reverse-swept.

FIGS. 3 & 4 show longitudinal section view of rocket motors with yet other conventional deep finocyl grains. In either case the leading edges 107c & 107d of fin 106c and 106d respectively are swept backward—characteristic of conventional finocyl grains.

Few of the prior inventions dealing with conventional finocyl grains follow.

A finocyl grain disclosed in US 00000108211 (Andrew) describes a configuration used in large monolithic boosters. The aft-end located fin is dissimilar but their leading edges are swept backwards as in any conventional finocyl grain.

Another finocyl grain disclosed in U.S. Pat. No. 4,936,092 (Andrew) depicts a compact, monolithic grain configuration with deep fin cavities at the aft-end of the motor. Again the leading edges of the fin are reverse-swept.

Yet another finocyl grain disclosed in U.S. Pat. No. 4,148,187 (Younkin) relates to a multi-piece grain configuration for modulated thrust profiles. Illustrating figures show typical finocyl grains with reverse-swept fin leading edges.

### SUMMARY

The present disclosure relates to a solid rocket motor. The rocket motor comprises an internally insulated cylindrical casing with end domes having centrally located apertures at fore-end and aft-end. The rocket motor further comprises a solid propellant grain filled within the casing. The grain comprises an axial through-bore running from fore-end to aft-end along the axis of the rocket motor. The grain further comprises a plurality of longitudinal fin cavities formed in a circular array around the said axial through-bore at the aft-end of the rocket motor. Each of the plurality of longitudinal hollow fin cavities extends radially outwards with forward-swept leading edge and trailing edge.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The features of the present disclosure will become more fully apparent from the following description and appended claims, taken in conjunction with the accompanying drawings. Understanding that these drawings depict only several embodiments in accordance with the disclosure and are therefore, not to be considered limiting of its scope. The disclosure will be described with additional specificity and detail through use of the accompanying drawings.

FIGS. 1a & 1b illustrate aft-end view and longitudinal sectional view (along section A-A) respectively of a conventional monolithic rocket motor with conventional shallow finocyl grain in accordance with the Prior Art;

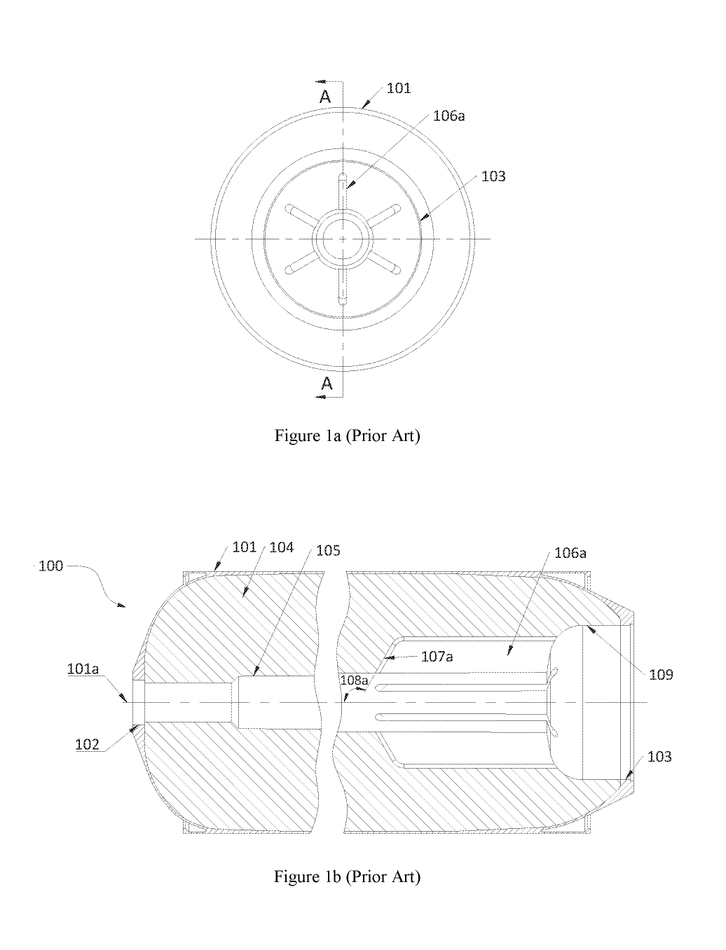

FIGS. 2, 3 & 4 illustrate longitudinal sectional view of rocket motors with different conventional deep finocyl grain configurations in accordance with the Prior Art;

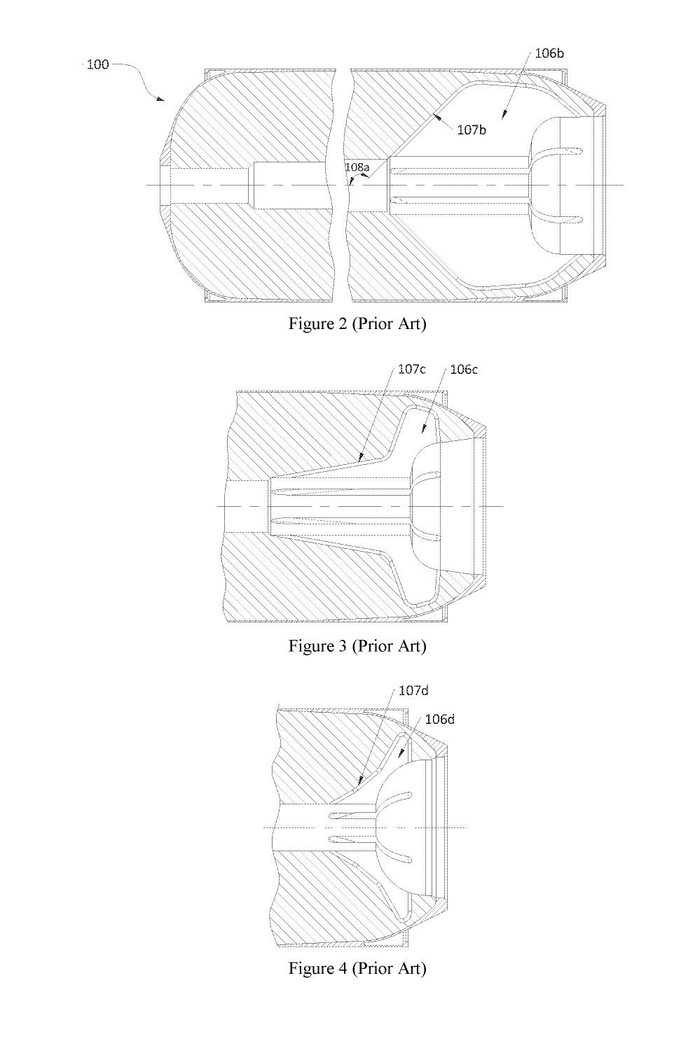

FIGS. 5a & 5b illustrate longitudinal view and cross-sectional view (along section B-B) respectively of an exemplary solid rocket motor propellant grain configuration in accordance with an embodiment of the present disclosure;

FIGS. 6, 7 & 8 show longitudinal sectional views of exemplary embodiments of the propellant grain with different geometry of forward-swept fin in accordance with some embodiments of the present disclosure;

FIGS. 9 & 10 illustrate the longitudinal and cross-sectional views (along section C-C) respectively of dissimilar forward-swept fin cavities in accordance with an embodiment of the present disclosure;

FIGS. 11 & 12 graphical representations of exemplary rocket motor chamber pressure versus time profiles achieved by the grain configuration in accordance with some embodiments of the present disclosure;

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternative falling within the scope of the invention.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following description is, therefore, not to be taken in a limiting sense. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure relates to a propellant grain configuration in rocket motors. In one embodiment, the coaxial, case-bonded, monolithic solid rocket propellant grain comprises a plurality of forward-swept, deep, longitudinal fin cavities circular-patterned about an axial conical and/or cylindrical cavity. It provides significant flexibility in thrust profile tailoring as well as high volumetric loading density.

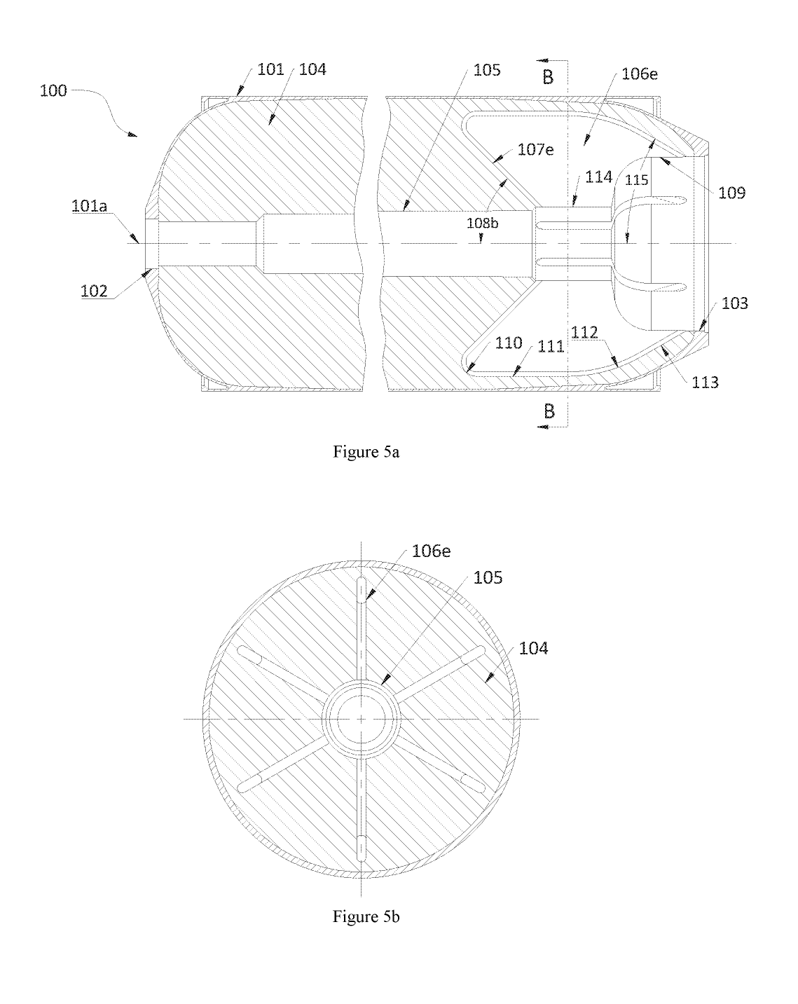

FIGS. 5a & 5b illustrate show the longitudinal view and cross sectional view (along section B-B) of an exemplary solid propellant rocket motor loaded with propellant grain configuration in accordance with one embodiment of the present disclosure;

As illustrated in FIG. 5a, the solid propellant rocket motor (hereinafter referred to as rocket motor) 100 may be a monolithic rocket motor with grain configuration 104 bonded to the casing 101 of the rocket motor 100.

In one embodiment, the rocket motor 100 comprises a hollow casing 101 with fore-end 102 and aft-end 103 apertures. In one example, the fore-end aperture 102 may be smaller than the aft-end aperture 103. The casing 101 may be a cylindrical structure with convex end domes and internally insulated with a suitable insulating material. The propellant grain 104 may be cast inside the casing 101 and cured to final shape or machined to final shape. The rocket motor 100 further comprises an igniter (not shown) at the fore-end aperture 102 and a nozzle (not shown) at the aft-end aperture 103.

In one embodiment, the propellant grain 104 comprises the cylindrical cavity or axial through-bore 105 along the longitudinal axis 101a running from the fore-end aperture 102 to the aft-end aperture 103 of the rocket motor 100. In another embodiment, the propellant grain comprises a blind axial cavity opening towards the aft-end aperture. The shape of the central cavity or the blind axial cavity may be at least one of conical, cylindrical or combination of conical and cylindrical shapes. The propellant grain 104 further comprises the plurality of longitudinal hollow fin cavities (hereinafter referred to as “fin”) 106e. The fin 106e is circular-patterned about the longitudinal axis 101a and located near the aft-end aperture 103. The propellant grain 104 further comprises the counter-bore 109 near the aft-end aperture 103 to accommodate the submerged nozzle (not shown) of the rocket motor 100.

As shown in FIG. 5a, the fin 106e is formed by forward-swept leading edges 107e, small fillet radii 110, fin tip-chord 111, forward-swept trailing edges 112, large fillet radii 113 and fin root-chord 114.

In one embodiment, the fin 106 is configured with their leading edges (107) making an acute angle at least one of completely 107e, 107i, partly 107f, 107g and tangentially 107h with the forward motor axis 101a. The fin 106e is configured such that the acute angular dimension 114 made by the leading edge 108b with forward motor axis 101a is greater than the angular dimension 115 made by the trailing edge 111 with the forward motor axis 101a. The angular dimensions 108b, 115 made the by leading edge 107e and trailing edge 111 respectively with the forward motor axis 101a is acute (less than 90 degrees) and hence the leading and trailing edges of the fin are termed forward-swept.

The fin 106e is configured with increasing thickness from the tip to root and the maximum size of the fin 106e related to the diameter of the counter-bore 109 and aft-end aperture 103. In one embodiment, the maximum size of the fin 106e is determined such that the diameter of the largest circle inscribed on radial side of the fin 106e is lesser than the diameter of the counter-bore 109 and the aft-end aperture 103 in the motor casing 101. In other embodiment, the forward-swept leading edge 107e of the plurality of fin 106e is configured to form one or more acute angular dimensions with the forward motor axis 101a. The tip-chord 110 is configured to run parallel to local casing insulation.

FIG. 5b illustrates distribution of the fin 106e in propellant grain 104 around the central cavity 105. The extent of radial depth of fin 106e is illustrated in FIG. 5b. The fin 106e is configured with circular tips. Further, the fin 106e is disposed about the axial through-bore 105 such that the diameter of the largest imaginary circle circumscribing the tips of the fin 106e is greater than the diameter of the aft-end aperture 103 in motor casing 101 and lesser than the inner diameter of the motor casing 101.

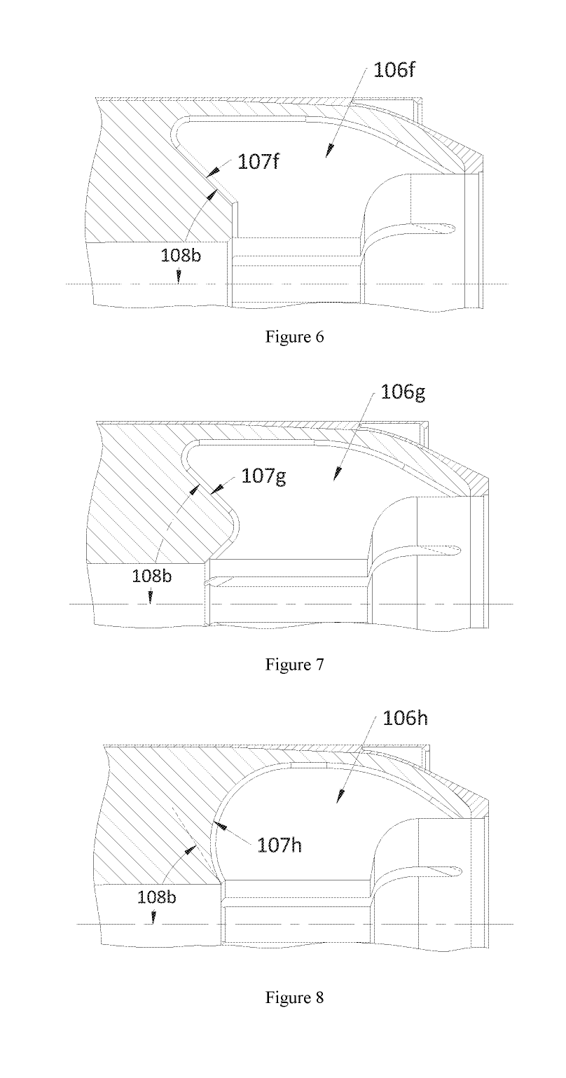

FIG. 6 illustrates an exemplary embodiment of fin geometry where the forward-swept leading edge 107f of the fin 106f is at least partially perpendicular to the motor axis 101a.

In another embodiment, as shown in FIG. 7, the inner part of the forward-swept leading edge 107e is reverse swept.

Also as illustrated in FIG. 8, in yet another embodiment, the leading edge 107h is part of an arc with the tangent at the starting point of the fin 106h forming acute angle 114 with the forward motor axis.

In one embodiment, the forward-swept leading edge 107e is configured to form one or more angular dimensions with the motor axis 101a including single, double or triple delta fin.

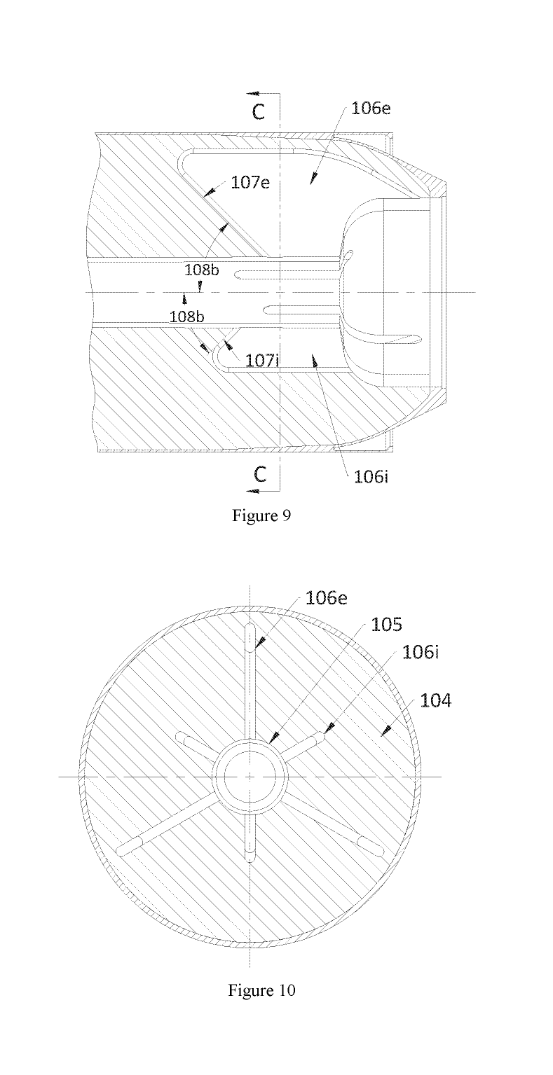

FIGS. 9 & 10 illustrate longitudinal and cross sectional views of yet another embodiment where the circular patterned fin are dissimilar in dimensions. Alternate forward-swept fin are similar. Fin 106e and 106i differ in their radial depth among other dimensions.

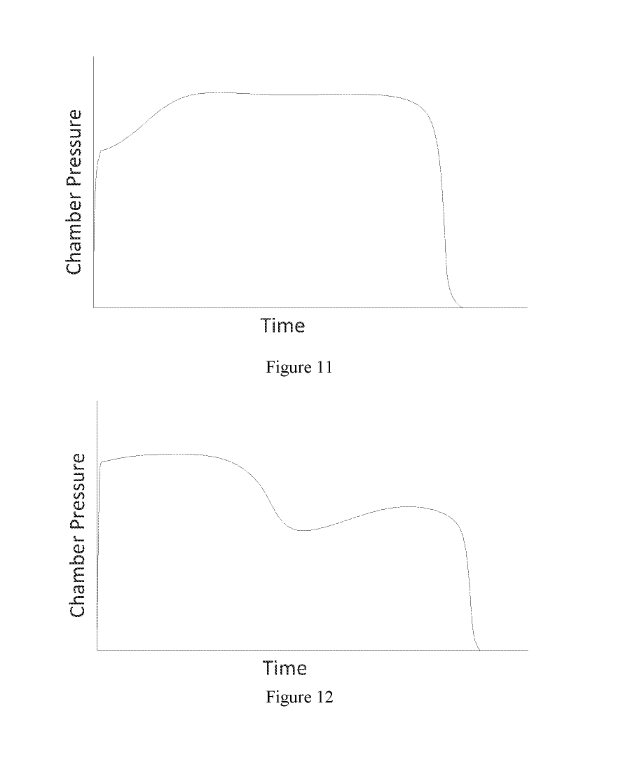

FIGS. 11 & 12 illustrate two of the many possible rocket motor chamber pressure profiles generated by different embodiments of the current invention. FIG. 11 shows a ‘progressive—neutral’ type of ‘chamber pressure vs. time’ plot where the initial lower pressure ensures less loads on the thick propellant grain. An ‘M-type’ chamber pressure vs. time plot is shown in FIG. 12. The dip in pressure level is usually synchronized with maximum atmospheric loads in case of launch vehicles.

### ADVANTAGES OF THE PRESENT INVENTION

In one embodiment, the present disclosure relates to propellant grain configuration having a plurality of deep longitudinal fin cavities with forward-swept leading edges circular patterned about an axial cavity. The grain configuration provides flexibility to tailor burn surface area regression profiles to meet different performance requirements.

Further, being a finocyl grain configuration it enables high propellant volumetric loading density enabling a compact rocket motor.

### REFERENCE NUMERALS USED IN THE PRESENT INVENTION

100—Rocket motor
101—Motor casing
101a—Motor axis
102—Fore-end aperture
103—Aft-end aperture
104—Solid Propellant grain
105—Axial through-bore
106a, 106b, 106c, 106d, 106e, 106f, 106g, 106h, 106i—Fin
107a, 107b, 107c, 107d, 107e, 107f, 107g, 107h, 107i—Leading edge
108a—Angular dimension between the leading edge and forward motor axis
109—Counter-bore in Propellant grain
110—Small fillet radii of fin
111—Fin tip-chord
112—Trailing edge of fin
113—Large fillet radii of fin
114—Fin root-chord
108b—Angular dimension between fin leading edge and forward motor axis
115—Angular dimension between fin trailing edge and forward motor axis

The foregoing detailed description has described only a few of the many possible implementations of the present invention. While considerable emphasis has been placed herein on the particular features of this invention, it will be appreciated that various modifications can be made, and that many changes can be made in the preferred embodiments without departing from the principles of the invention. These and other modifications in the nature of the invention or the preferred embodiments will be apparent to those skilled in the art from the disclosure herein, whereby it is to be distinctly understood that the foregoing descriptive matter is to be interpreted merely as illustrative of the invention and not as a limitation.

1. A rocket motor, the rocket motor comprising:
an internally insulated cylindrical casing with end domes having centrally located apertures at fore-end and aft-end;
a solid propellant grain filled within the casing, comprising:
an axial through-bore running from fore-end to aft-end along the axis of the rocket motor; and
a plurality of longitudinal fin cavities circular patterned about the axial through-bore,
wherein the plurality of longitudinal fin cavities extend radially outward with forward-swept leading edge and trailing edge.

2. The rocket motor as claimed in claim 1, wherein the solid propellant grain further comprises a counter-bore at the aft-end of the rocket motor.

3. The rocket motor as claimed in claim 1, wherein the plurality of longitudinal fin cavities is configured with their leading edges making an acute angle at least one of completely, partly and tangentially with the forward motor axis.

4. The rocket motor as claimed in claim 1, wherein the plurality of longitudinal fin cavities disposed about the axial through-bore are dissimilar.

5. The rocket motor as claimed in claim 1, wherein the plurality of longitudinal fin cavities is disposed about the axial through-bore such that the diameter of the largest imaginary circle circumscribing the tips of the fin is greater than the diameter of the aft-end aperture in motor casing and lesser than the inner diameter of the motor casing.

6. The rocket motor as claimed in claim 1, wherein the plurality of longitudinal fin cavities is disposed such that the acute angular dimension made by the leading edge with forward motor axis is greater than the angular dimension made by the trailing edge with the forward motor axis.

7. The rocket motor as claimed in claim 1, wherein the plurality of longitudinal hollow fin is configured with increasing thickness from the tip-chord to root of the longitudinal fin cavities.

8. The rocket motor as claimed in claim 1, wherein maximum size of the plurality of longitudinal fin cavities is such that the diameter of the largest circle inscribed on radial side of the fin is lesser than the diameter of the counter-bore and the aft-end aperture in the motor casing.

9. The propellant grain as claimed in claim 1, wherein the forward-swept leading edge of the plurality of longitudinal fin cavities is configured to form one or more acute angular dimensions with the forward motor axis.
